(19) United States
(12) Patent Application Publication
(10) Pub. No.: US 2026/0267078 A1
(43) Pub. Date: Sep. 10, 2026

(54) OPTICAL COUPLING APPARATUS, FIBER ARRAY UNIT, AND METHOD FOR ASSEMBLING FIBER ARRAY UNIT

(71) Applicant: AIP Inc., New Taipei City (TW)

(72) Inventor: Chia LEE, New Taipei City (TW)

(21) Appl. No.: 19/674,552

(22) Filed: May 12, 2026

Related U.S. Application Data
(63) Continuation-in-part of application No. 18/510,668, filed on Nov. 16, 2023, now Pat. No. 12,656,561.
(60) Provisional application No. 64/045,240, filed on Apr. 21, 2026.
(60) Provisional application No. 63/528,933, filed on Jul. 26, 2023.

(51) Int. Cl. G02B 6/38

(52) U.S. Cl. CPC G02B 6/3834; G02B 6/3854; G02B 6/3861

(57) ABSTRACT

An optical coupling apparatus, a fiber array unit, and a method for assembling the fiber array unit are provided. The optical coupling apparatus includes a coupling unit and a fiber array unit detachably connected to the coupling unit. The coupling unit includes a connecting base and a waveguide device disposed on the connecting base. The fiber array unit includes a ferrule body, a holding structure disposed in the ferrule body, and a plurality of optical fibers. The holding structure includes a front holding block and a guide holding block attached to the front holding block. The front holding block defines a plurality of front passages, the guide holding block defines a plurality of guide passages arranged in alignment with the front passages, and the optical fibers sequentially pass through the guide passages and front passages.

### CROSS REFERENCE TO RELATED APPLICATIONS

This application claims the benefit of U.S. provisional patent application Ser. No. 64/045,240, filed April 21, 2026, the entirety of which is incorporated by reference herein.

This application is a continuation-in-part of Ser. No. 18/510,668, filed November 16, 2023, which claims the priority of U.S. provisional patent application Ser. No. 63/528,933, filed July 26, 2023, the entireties of which are incorporated by reference herein.

### BACKGROUND OF INVENTION

### FIELD OF INVENTION

The present invention relates to a technical field of optical coupling, and particularly to an optical coupling apparatus, a fiber array unit, and a method for assembling the fiber array unit.

### RELATED ART

Photonic integrated circuits (PICs) have been widely used for optical communication to address the explosive demand for computing speed that brings great benefits to the industries requiring high-performance data exchange, long-distance interconnection, 5G facilities, and computing equipment. Conventional optical signal devices are primarily connected to transmit optical signals via fiber array units (FAUs). However, there is currently no effective solution to address the issue of unstable signal transmission between an FAU and a corresponding optical signal device due to differences in material properties. In addition, during insertion of optical fibers, a conventional FAU is prone to snagging the optical fibers on fiber passages, which may result in misalignment and damage to the optical fibers.

### SUMMARY OF INVENTION

An object of the present application is to provide a fiber array unit enabling efficient and precise assembly between optical fibers and an end-positioning element.

Another object of the present application is to provide an optical coupling apparatus capable of preventing temperature drift caused by differences in thermal expansion between two components during use.

Still another object of the present application is to provide a method for assembling a fiber array unit for preventing breakage of optical fibers during insertion.

To achieve the above-mentioned objects, the present application provides a fiber array unit, including a holding structure and a plurality of optical fibers. The holding structure includes a front holding block and a guide holding block attached to the front holding block. The front holding block defines a plurality of front passages, and the guide holding block defines a plurality of guide passages arranged in alignment with the front passages. The optical fibers each having a first end portion sequentially pass through the respective guide passages and front passages and secured in the holding structure.

Optionally, each of the guide passages has a diameter greater than a diameter of each of the front passages.

Optionally, each of the guide passages defines a guide enlarged opening located at an end of the guide passage away from the front holding block, and the guide enlarged opening has a peripheral surface that radially expands to a diameter greater than that of the guide passage.

Optionally, each of the front passages defines a front enlarged opening located an end of the front passage adjacent to the corresponding guide passage of the guide holding block, and the front enlarged opening has a peripheral surface that radially expands to a diameter greater than that of the front passage.

Optionally, the guide holding block has a depth greater than that of the front holding block in an extension direction of the guide passages.

Optionally, the guide passages are coaxially aligned with the front passages.

Optionally, the fiber array unit further includes an intermediate holding block disposed between the front holding block and the guide holding block. The intermediate holding block includes a plurality of intermediate passages located corresponding to the front passages and the guide passages, such that the first end portions of the optical fibers sequentially pass through the respective guide passages, intermediate passages, and front passages.

Optionally, the fiber array unit further includes a ferrule body. The ferrule body includes two limiting walls, and defines a fixing groove located between the two limiting walls and a rear slot communicating with the fixing groove. The holding structure is disposed in the fixing groove, and the optical fibers pass through the rear slot to be secured in the holding structure.

Optionally, the ferrule body is made of a material including at least one of liquid crystal polymer, Kovar, or polyphenylene sulfide.

Optionally, the front holding block and the guide holding block are each made of a material including at least one of glass, ceramic, or liquid crystal polymer.

The present application further provides an optical coupling apparatus, adapted for optical coupling between a photonic integrated circuit and an associated device, including a coupling unit and a fiber array unit. The coupling unit includes a connecting base and a waveguide device disposed on the connecting base. The fiber array unit is detachably connected to the coupling unit and includes a ferrule body, a holding structure disposed in the ferrule body, and a plurality of optical fibers. The holding structure includes a front holding block and a guide holding block attached to the front holding block. The front holding block defines a plurality of front passages. The guide holding block defines a plurality of guide passages arranged in alignment with the front passages, and the optical fibers sequentially pass through the guide passages and front passages.

Optionally, the connecting base is disposed on the photonic integrated circuit, the waveguide device is optically coupled to the photonic integrated circuit, and the waveguide device includes a plurality of optical channels arranged in an array and aligned with the respective front passages.

Optionally, the ferrule body includes two limiting walls and defines a fixing groove located between the two limiting walls, the holding structure is disposed in the fixing groove. A plurality of attaching portions are disposed on the limiting walls, and the connecting base comprises a plurality of positioning elements configured to be detachably connected to the attaching portions.

Optionally, each of the guide passages has a diameter greater than a diameter of each of the front passages.

Optionally, each of the guide passages defines a guide enlarged opening located at an end of the guide passage away from the front holding block, and the guide enlarged opening has a peripheral surface that radially expands to a diameter greater than that of the guide passage.

Optionally, the guide holding block has a depth greater than that of the front holding block in an extension direction of the guide passages.

Optionally, the connecting base and the ferrule body are each made of a material comprising at least one of liquid crystal polymer, Kovar, or polyphenylene sulfide.

The present application further provides a method for assembling a fiber array unit, including: providing a holding structure comprising a front holding block and a guide holding block attached to the front holding block, and the front holding block defines a plurality of front passages, the guide holding block defines a plurality of guide passages arranged in alignment with the front passages, and each of the guide passages has a diameter greater than that of each of the front passages; inserting first end portions of a plurality of optical fibers into the respective guide passages; and moving at least one of the holding structure or the optical fibers relative to each other until the first end portions of the optical fibers pass through the guide passages to be positioned in the respective front passages.

Optionally, the method further includes passing the optical fibers, with the first end portions thereof secured in the holding structure, through a rear slot and a fixing groove each formed in a ferrule body; and securing the holding structure in the fixing groove of the ferrule body.

Optionally, the step of inserting the first end portions of the plurality of optical fibers into the respective guide passages includes: filling each of the guide passages of the guide holding block with glue; and inserting the first end portions of the optical fibers into the respective guide passages until the first end portions protrude from the guide passages toward the front holding block. The step of moving at least one of the holding structure or the optical fibers relative to each other until the first end portions of the optical fibers pass through the guide passages to be positioned in the respective front passages includes: filling each of the front passages of the front holding block with glue; attaching the guide holding block along with the first end portions of the optical fibers to the front holding block, such that the guide passages are coaxially aligned with the front passages; moving at least one of the holding structure or the optical fibers relative to each other until the first end portions of the optical fibers are positioned in the respective front passages; and securing the first end portions of the optical fibers in the holding structure by curing the glue in the guide passages and the front passages.

### BRIEF DESCRIPTION OF DRAWINGS

FIG. 1 is a schematic exploded perspective view of a fiber array unit in accordance with an embodiment of the present application.

FIG. 2 is a schematic exploded perspective view of the fiber array unit shown in FIG. 1 from another perspective.

FIG. 3 is a schematic assembly view of a fiber array unit in accordance with an embodiment of the present application.

FIG. 4 is a schematic perspective view of a fiber array unit in accordance with an embodiment of the present application.

FIG. 5 is a schematic cross-sectional view showing a guide holding block of a holding structure in accordance with an embodiment of the present application.

FIG. 6 is a schematic cross-sectional view of showing a holding structure in accordance with an embodiment of the present application.

FIG. 7 is a schematic cross-sectional view of a holding structure in accordance with an embodiment of the present application.

FIG. 8 is a schematic exploded perspective view of an optical coupling apparatus in accordance an embodiment with the present application.

FIG. 9 is a schematic exploded perspective view of the optical coupling apparatus shown in FIG. 8 from another perspective.

FIG. 10 is a schematic cross-sectional view of an optical coupling apparatus in accordance with an embodiment of the present application.

FIG. 11A is a schematic side view of an optical coupling apparatus in accordance with an embodiment of the present application.

FIG. 11B is a schematic side view of an optical coupling apparatus in accordance with an embodiment of the present application.

FIG. 11C is a schematic side view of an optical coupling apparatus in accordance with an embodiment of the present application.

FIG. 12 is a schematic exploded perspective view of an optical coupling apparatus in accordance an embodiment of the present application.

FIG. 13 is an exploded perspective view of the optical coupling apparatus shown in FIG. 11 from another perspective.

FIG. 14 is a schematic cross-sectional view of the optical coupling apparatus shown in FIG. 13.

FIG. 15 is a flowchart of a method for assembling a fiber array unit in accordance with an embodiment of the present application.

### DESCRIPTION OF PREFERRED EMBODIMENTS

The following embodiments are referring to the drawings for exemplifying specific implementable embodiments of the present application. Directional terms described by the present application, such as upper, lower, front, back, left, right, inner, outer, side, etc., are only directions by referring to the drawings, and thus the directional terms are used to describe and understand the present application, but the present application is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed as a second element, a second component or a second section without departing from the teachings of the present application.

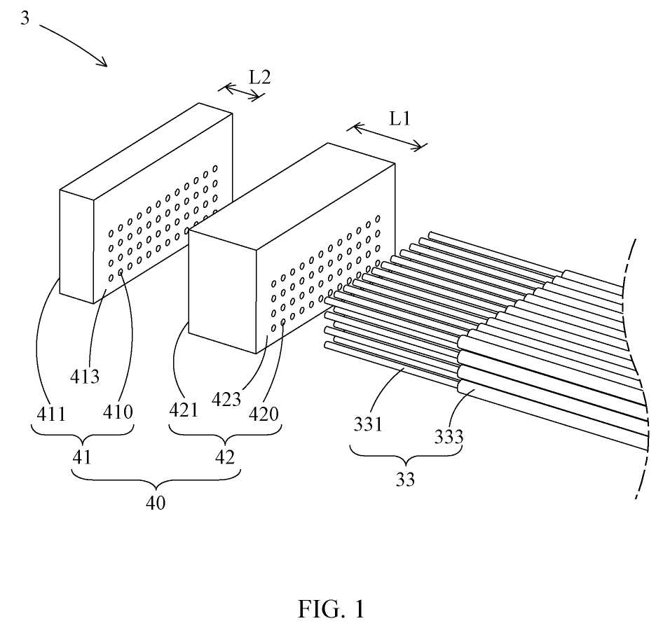

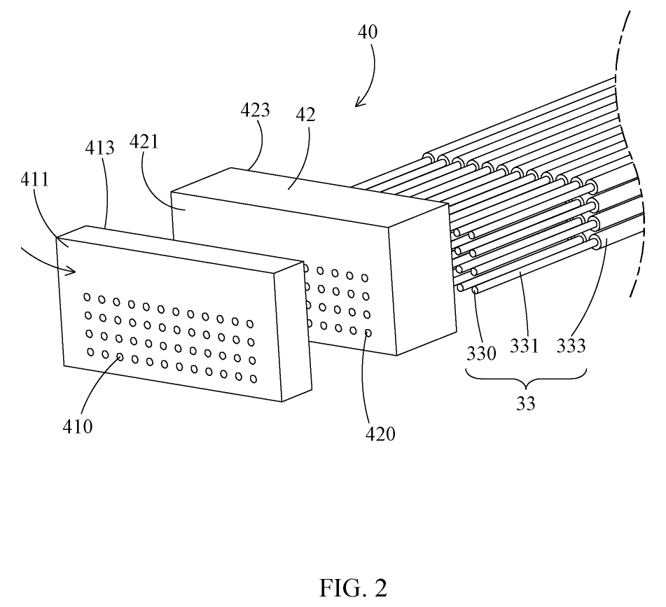

In a first aspect, the present application provides a fiber array unit configured to facilitate insertion and positioning of optical fibers relative to an end-positioning element, thereby enabling efficient and precise assembly between the optical fibers and the end-positioning element. Referring to FIGS. 1 and 2, FIG. 1 illustrates a schematic exploded perspective view of a fiber array unit 3 in accordance with an embodiment of the present application, and FIG. 2 is a schematic exploded perspective view of the fiber array unit 3 shown in FIG. 1 from another perspective. As shown in FIGS. 1 and 2, the fiber array unit 3 includes a plurality of optical fibers 33 and a holding structure 40. The optical fibers 33 are arranged in an array including multiple rows and columns, and each of the optical fibers 33 may include a fiber core 330, a cladding layer 331, and an outer jacket 333 that are concentrically arranged from inside to outside. In some embodiments, a fiber diameter (including the fiber core 330 and the cladding layer 331) of each optical fiber 33 may be 125 microns (µm) but is not limited thereto.

As shown in FIGS. 1 and 2, the holding structure 40 includes a front holding block 41 and a guide holding block 42 attached to the front holding block 41. Specifically, the front holding block 41 defines a plurality of front passages 410, and the guide holding block 42 defines a plurality of guide passages 420 coaxially aligned with the front passages 410 in a one-to-one correspondence. In detail, the front holding block 41 includes a front coupling surface 411, a rear contact surface 413 disposed opposite to the front coupling surface 411, and the front passages 410 passing through the rear contact surface 413 and the front coupling surface 411. The guide holding block 42 includes a front guide surface 421 facing the rear contact surface 413, a rear guiding surface 423 disposed opposite to the front guide surface 421, and the guide passages 420 passing through the rear guiding surface 423 and the front guide surface 421. The front passages 410 and the guide passages 420 are configured for insertion of the optical fibers 33.

Referring to FIG. 3 in conjunction with FIGS. 1 and 2, FIG. 3 illustrates a schematic assembly view of the front holding block 41, the guide holding 42, and the optical fibers 33. As shown in FIG. 3, the guide passages 420 are coaxially aligned with the front passages 410 and collectively form a plurality of passage units 401 with the front passages 410. The passage units 401 are configured to hold first end portions 33a of the optical fibers 33, respectively. In some embodiments, the passage units 401 may be formed through a laser drilling process and are configured to enable the optical fibers 33 to pass through. Specifically, each of the first end portions 33a sequentially passes through the respective one of the guide passages 420 and front passages 410 so as to be secured in the holding structure 40. Preferably, an adhesive material (not shown) is applied between the front holding block 41 and the guide holding block 42 to facilitate securing of the first end portions 33a of the optical fibers 33 in the passage units 401.

As shown in FIGS. 1 to 3, the guide holding block 42 has a depth L1 greater than a depth L2 of the front holding block 41 in an extension direction of the guide passages 420. The greater length of the guide holding block 42 results in the guide passage 420 having a greater length than the front passage 410, thereby reducing the difficulty of the insertion of a respective optical fiber 33 and facilitating preliminary insertion of the optical fiber 33. As shown in FIG. 3, at least the outer jacket layer 333 is removed in advance at the end portion 33a for ease of the insertion of the optical fiber 33, and the distal end of the end portion 33a may be aligned with the front coupling surface 411 for edge coupling. In some embodiments, the front holding block 41 and the guide holding block 42 are each made of a material including at least one of glass, ceramic, or liquid crystal polymer, but is not limited thereto.

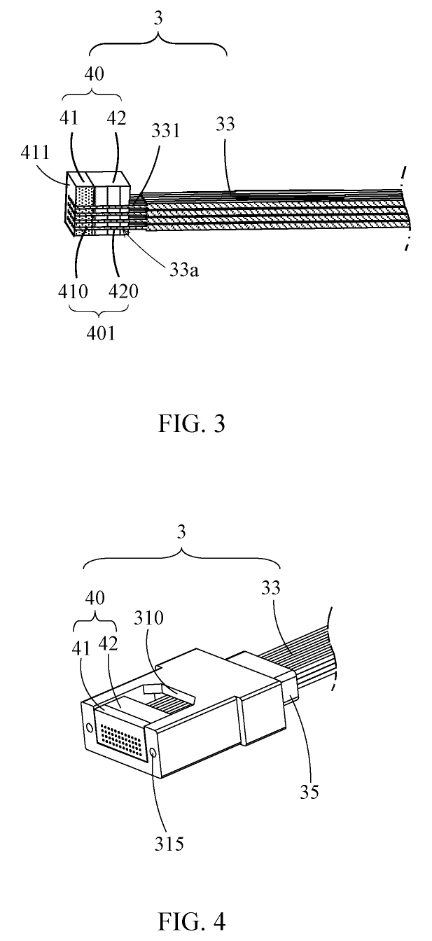

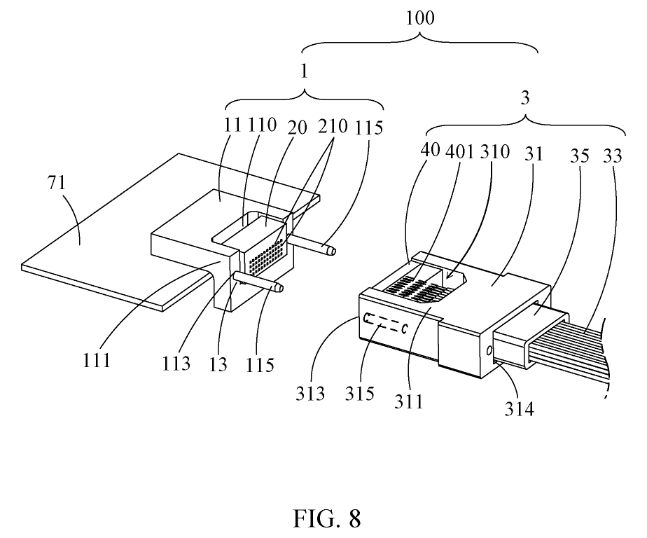

Referring to FIG. 4, illustrating a schematic perspective view of a fiber array unit 3 in accordance with an embodiment of the present application, the fiber array unit 3 shown in FIG. 4 further includes a ferrule body 31 and a retaining block 35. The ferrule body 31 is configured to support and protect the holding structure 40. In some embodiments, the ferrule body 31 includes two limiting walls 311, and forms a fixing groove 310 located between the two limiting walls 311 and a rear slot 314 (as shown in FIG. 8) communicating with the fixing groove 310. As shown in FIG. 4, the holding structure 40 is disposed within the fixing groove 310, and the first end portions 33a of the optical fibers 33 pass through the rear slot 314 to be secured in the holding structure 40 and ends of the optical fibers 33 are connected to an associated device (not shown). In some embodiments, the holding structure 40 may be adhesively secured in the fixing groove 310 or soldered to the ferrule body 31. Two attaching portions 315 are formed in the limiting walls 311 and configured to connect to corresponding positioning elements 115 (as shown in FIG. 8).

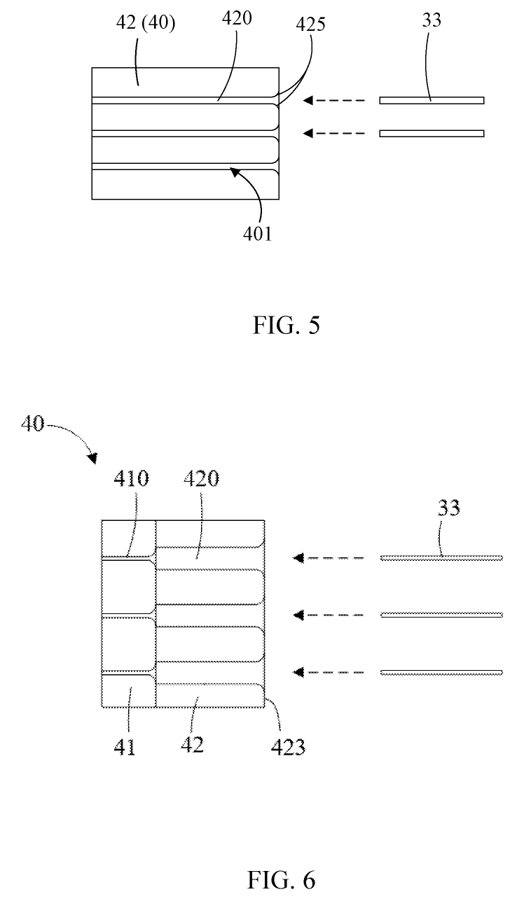

Referring to FIG. 5, FIG. 5 is a schematic cross-sectional view showing the guide holding block 42 of the holding structure 40 in accordance with an embodiment of the present application. Each of the guide passages 420 of the guide holding block 42 defines a guide enlarged opening 425 located at an end of the guide passage 420 away from the front holding block 41. In some embodiments, the guide enlarged opening 425 has a peripheral surface that radially expands to a diameter greater than that of the guide passage 420. Specifically, the guide enlarged opening 425 is provided with an arc surface surrounding the guide enlarged opening 425 to guide and facilitate the insertion of the optical fiber 33, thereby preventing the optical fiber 33 from impacting against or being snagged by the holding structure 40 during insertion, which might otherwise cause breakage of the optical fiber 33 and result in insertion failure.

Referring to FIG. 6 and FIG. 5, FIG. 6 is a schematic cross-sectional view of the holding structure 40 in accordance with an embodiment of the present application. Each of the guide passages 420 has a diameter greater than a diameter of each front passages 410, and a fiber diameter of the optical fiber 33 is less than the diameter of each of the front passage 410 and the guide passage 420. In some embodiments, a diameter of the front passage 410 is in the range of 125.2 µm to 126 µm, and a diameter of the guide passage 420 is in the range of 126 to 128. During insertion of the optical fibers 33, each optical fiber 33 is sequentially inserted into the guide passage 420 and the front passage 410 from the rear guiding surface 423. The relatively large diameter of the guide passage 420 facilitates preliminary insertion of the optical fiber 33, thereby reducing alignment difficulty between the optical fiber 33 and the front passage 410.

As shown in FIG. 6, each of the front passages 410 defines a front enlarged opening 415 located an end of the front passage 410 adjacent to the corresponding guide passage 420 of the guide holding block 42. In some embodiments, the front enlarged opening 415 has a peripheral surface that radially expands to a diameter greater than that of the front passage 410. Specifically, the front enlarged opening 415 is provided with an arc surface surrounding the front enlarged opening 415 to guide and facilitate the insertion of the optical fiber 33, thereby preventing the optical fiber 33 from impacting against or being snagged by the front holding block 41 during insertion, which might otherwise cause breakage of the optical fiber 33 and result in insertion failure.

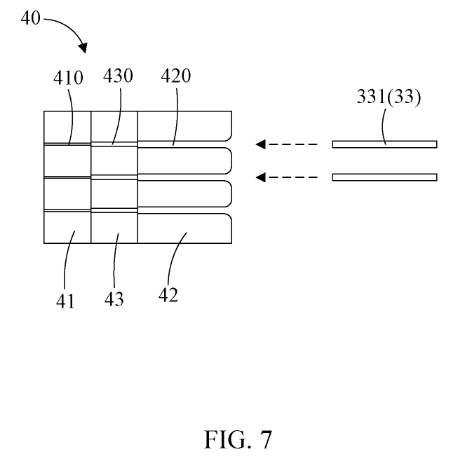

Referring to FIG. 7, showing a schematic cross-sectional view of a holding structure 40 in accordance with an embodiment of the present application, in this embodiment, the holding structure 40 further includes an intermediate holding block 43 disposed between the front holding block 41 and the guide holding block 42. The intermediate holding block 43 includes a plurality of intermediate passages 430 located corresponding to the front passages 410 and the guide passages 420. Preferably, the intermediate passages 430 are coaxially aligned with the front passages 410 and the guide passages 420. Specifically, each of the intermediate passages 430 has a diameter smaller than that of the guide passage 420 but larger than that of the front passage 410, so that the first end portions 33a of the optical fibers 33 is capable of sequentially passing through the respective guide passages 420, intermediate passages 430, and front passages 410, thereby facilitating smooth insertion of the optical fiber 33.

In a second aspect, the present application provides an optical coupling apparatus configured for optical transmission between a photonic integrated circuit (PIC) and at least one associated device. In some embodiments, the photonic integrated circuit may be disposed on a multi-chip module including electronic integrated circuits (EICs) and photonic integrated circuits that may be co-packaged for electro-optic conversion or opto-electronic conversion.

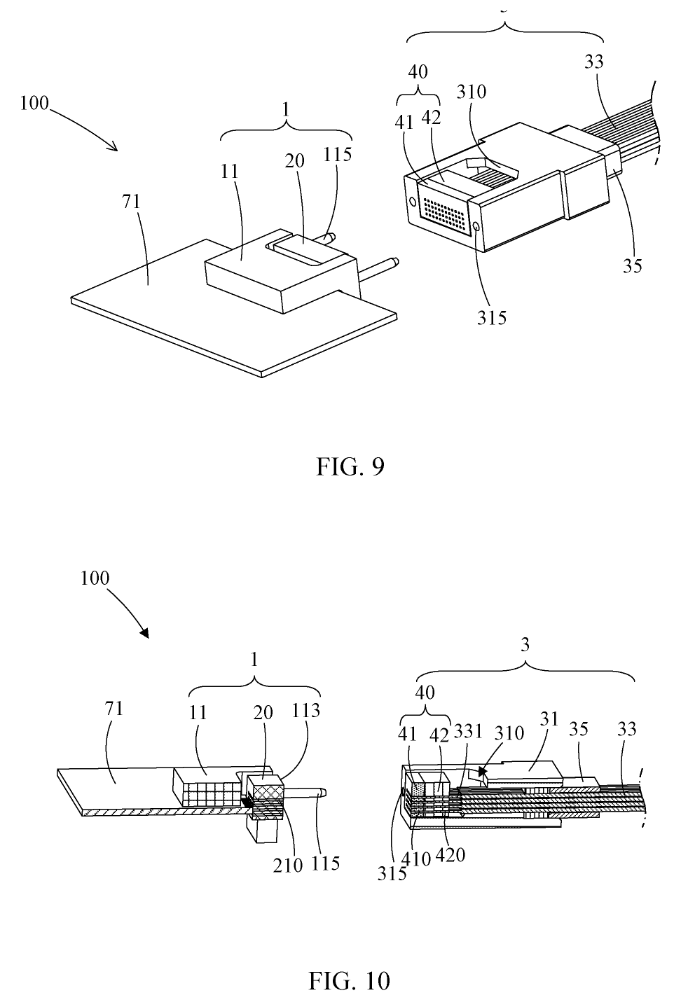

Referring to FIGS. 8 to 10, FIG. 8 is a schematic exploded perspective view of an optical coupling apparatus 100 in accordance an embodiment with the present application, FIG. 9 is a schematic exploded perspective view of the optical coupling apparatus 100 shown in FIG. 8 from another perspective, and FIG. 10 is a schematic cross-sectional view of the optical coupling apparatus 100. The optical coupling apparatus 100 includes a coupling unit 1 and a fiber array unit 3 detachably connected to the coupling unit 1. It should be noted that the fiber array unit 3 of the optical coupling apparatus 100 is the same as the fiber array unit 3 and described in the above-mentioned embodiments. Therefore, detailed descriptions of the fiber array unit 3 of the optical coupling apparatus 100 will not be repeated herein. As shown in FIGS. 8 and 9, the coupling unit 1 includes a connecting base 11 and a waveguide device 20 disposed on the connecting base 11. Specifically, the connecting base 11 is disposed to adjoin a photonic integrated circuit 71, the waveguide device 20 is optically coupled to the photonic integrated circuit 71.

As shown in FIGS. 8 and 9, in some embodiments, the connecting base 11 is disposed on a top surface of the photonic integrated circuit 71 and includes two positioning walls 111 disposed opposite to each other, an accommodating portion 110 formed between the positioning walls 111, a mating surface 113 is defined on an end of the connecting base 11 facing the fiber array unit 3, two positioning elements 115 disposed on the mating surface 113, and two retaining portions 13 extending downward from the positioning walls 111, respectively. In detail, the accommodating portion 110 is formed between the positioning walls 111 and passing through at least a bottom surface and a front surface of the connecting base 11. The positioning elements 115 are pin-like in shape and extend toward the fiber array unit 3. As shown in FIG. 8, a front end 313 is defined on an end of each of the limiting walls 311 facing the mating surface 113 of the connecting base 11. The attaching portions 315 are groove-shaped in the limiting walls 311 and configured to snugly fit to the pin-like positioning elements 115. The retaining portions 13 are positioned in front of an edge of the photonic integrated circuit 71 and configured to abut against the fiber array unit 3 during the plugging of the fiber array unit 3, thereby limiting the insertion travel of the fiber array unit 3. In addition, the retaining portions 13 also serve as a stop to limit displacement of the connecting base 11 in a direction perpendicular to the thickness of the photonic integrated circuit 71.

Still referring to FIGS. 8 to 10, the waveguide device 20 is disposed in the accommodating portion 110 and includes a plurality of optical channels 210 that are arranged in an array and aligned with the respective front passages 410. In some embodiments, the waveguide device 20 may be formed using a material of such as silica, fused silica, silicone, quartz, glass, borosilicate glass, lithium niobate (LiNbO3), or polymers. Preferably, the waveguide device 20 is made of silica and includes a planar Lightwave circuit (PLC) structure including the optical channels 210. The PLC structure may be configured in various ways, including, but not limited to, a straight-line circuit, a splitter circuit, an arrayed waveguide grating wavelength multiplexer, and a cross connect-type circuit.

Referring to FIG. 10 in conjunction with FIGS. 8 and 9, the connecting base 11 is made of a material having a coefficient of thermal expansion (CTE) similar to or equal to a coefficient of thermal expansion of the ferrule body 31. In detail, the connecting base 11 is made of a material capable of withstanding a relatively wide temperature range, for example, from about 20 °C to about 450 °C, and the material exhibits desirable characteristics including physical stability, machinability, thermal conductivity, and surface flatness. The connecting base 11 and the ferrule body 31 are made of materials having highly matched coefficients of thermal expansion, thereby preventing temperature drift caused by significant differences in thermal expansion between the two components during use, which could otherwise result in misalignment between the connecting base 11 and the ferrule body 31. In this embodiment, each of the connecting base 11 and the ferrule body 31 is made of a material including Kovar alloy, and the holding structure 40 is made of glass.

In some embodiments, the connecting base 11 is made of a material including Kovar alloy, and the ferrule body 31 is made of a material including polyphenylene sulfide (PPS). In other embodiments, the connecting base 11 and the ferrule body 31 are each made of a material including at least one of liquid crystal polymer or polyphenylene sulfide. It should be noted that the materials of the connecting base 11 and the ferrule body 31 are not limited thereto.

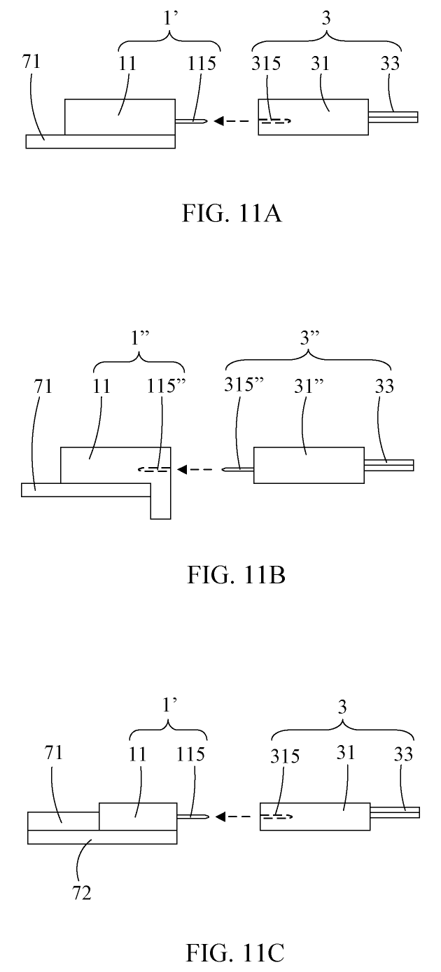

Referring to FIGS. 11A to 11C, each illustrating schematic side views of an optical coupling apparatus in accordance with different embodiments of the present application, the major differences between the optical coupling apparatus shown in FIGS. 11A to 11C and the optical coupling apparatus shown in FIGS. 8 and 9 are the configuration of the connecting base, the positioning elements, and the attaching portions. As shown in FIG. 11A, the photonic integrated circuit 71 is configured for surface coupling with a coupling unit 1’, and the coupling unit 1’ is provided without the retaining portion 13, thereby reducing the overall size of the coupling unit 1’. As shown in FIG. 11B, a coupling unit 1” includes two groove-like positioning element 115”, and a fiber array unit 3” includes two pin-like attaching portions 315” configured to connect to the positioning element 115”. As shown in FIG. 11C, the photonic integrated circuit 71 is disposed on a load board 72, and the coupling unit 1’ is disposed on the load board 72 in front of the photonic integrated circuit 71, such that the photonic integrated circuit 71 is configured for edge coupling with the coupling unit 1’, thereby providing a wider bandwidth and lower insertion loss.

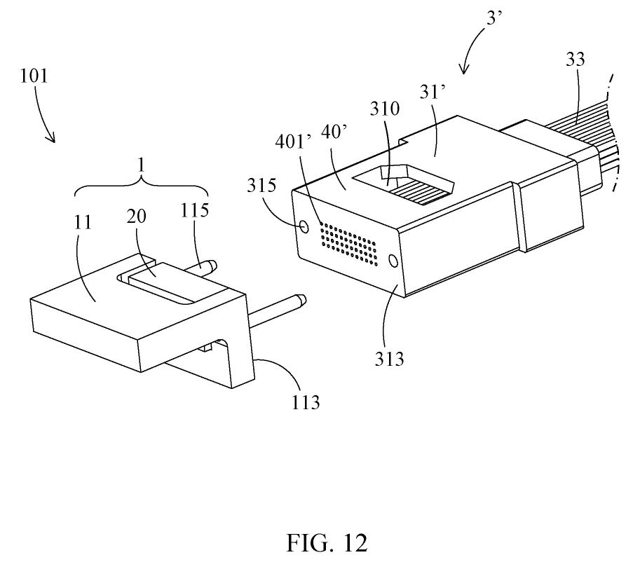

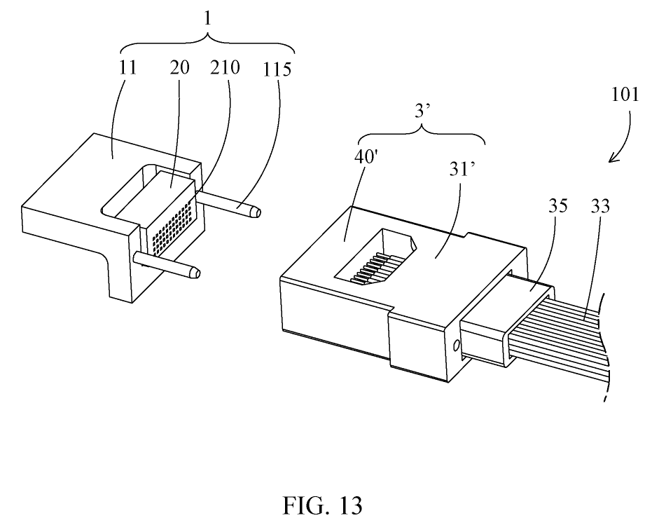

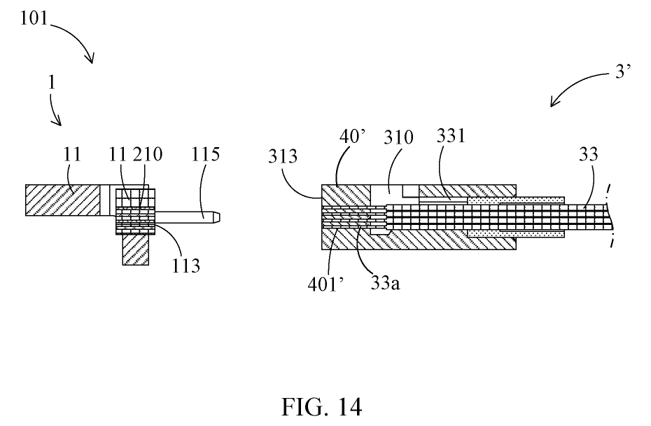

Referring to FIGS. 12 to 14, FIGS. 12 and 13 illustrate schematic exploded perspective views of an optical coupling apparatus 101 in accordance an embodiment of the present application, and FIG. 14 is a schematic cross-sectional view of the optical coupling apparatus 101 shown in FIG. 11. The optical coupling apparatus 101 is mainly different from the optical coupling apparatus 100 described in the above embodiments in the structure of a fiber array unit 3’. As shown in FIGS. 12 to 14, a holding structure 40’ is integrally formed with a ferrule body 31’ of a fiber array unit 3’. The integral formation of the ferrule body 31’ and the holding structure 40’ enhances the structural strength of the ferrule body 31’. The holding structure 40’ includes a plurality of passage units 401’ communicating with a fixing groove 310, and the first end portions 33a of the optical fibers 33 pass through the fixing groove 310 to be positioned in the passage units 401’.

In some embodiments, each of the passage units 401’ is formed into two segments (not shown) by a hole formation process, such as drilling. Specifically, the segment of the passage unit 401’ adjacent to the front end 313 has a diameter less than a diameter of the other segment of the passage units 401 away from the front end 313 for ease of insertion of the optical fiber 33. The two segments of each of the passage units 401 having different diameters may be integrally formed with the entire holding structure 40’ through a drilling technology, such as laser drilling, mechanical drilling, etching.

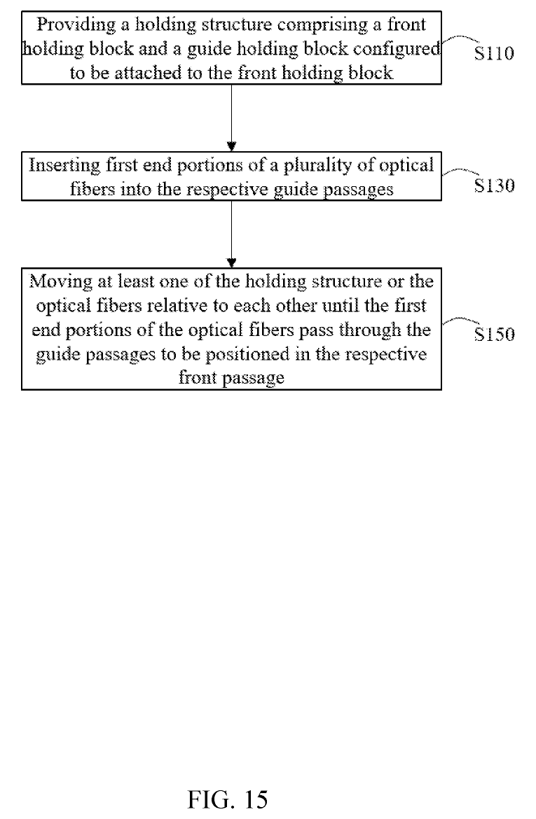

Referring to FIG. 15, illustrating a flowchart of a method for assembling a fiber array unit in accordance with an embodiment of the present application, the method is used to assemble the fiber array unit as shown in FIGS. 1 to 10. Therefore, descriptions of the fiber array unit will not be described in detailed here. As shown in FIG. 15, the method includes steps S110 to S150 as follows:

Step S110: providing a holding structure including a front holding block and a guide holding block configured to be attached to the front holding block. Specifically, the front holding block defines a plurality of front passages, the guide holding block defines a plurality of guide passages arranged in alignment with the front passages, and each of the guide passages has a diameter greater than that of each of the front passages. In some embodiments, the front holding block and the guide holding block are made of the same material, which may include at least one of glass, ceramic, or liquid crystal polymer, but is not limited thereto.

Step S130: inserting first end portions of a plurality of optical fibers into the respective guide passages of the guide holding block.

Step S150: moving at least one of the holding structure or the optical fibers relative to each other until the first end portions of the optical fibers pass through the guide passages to be positioned in the respective front passages.

In some embodiments, step S130 further includes: filling each of the guide passages with glue, and inserting the first end portions of the optical fibers into the respective guide passages until the first end portions protrude from the guide passages toward the front holding block. Specifically, the glue may be an optical epoxy and serves to temporarily secure the optical fibers in the guide passages before the glue is cured and to prevent the optical fibers from impacting against or being snagged by walls of the guide passages.

In some embodiments, step S150 further includes: filling each of the front passages of the front holding block with glue; aligning the guide holding block along with the first end portions of the optical fibers to the front holding block, such that the guide passages are coaxially aligned with the front passages; moving at least one of the front holding block or the optical fibers relative to each other until the first end portions of the optical fibers are positioned in the respective front passages and the guide holding block is attached to the front holding block; and securing the first end portions of the optical fibers in the holding structure by curing the glue in the guide passages and the front passages. Likewise, the glue may be an optical epoxy and serves to temporarily secure the optical fibers in the front passages before the glue is cured and to prevent the optical fibers from impacting against or being snagged by walls of the front passages.

As described above, the separate provision of the guide holding block and the front holding block effectively reduces a length of passages to be filled with the glue, thereby ensuring that the guide passages and the front passages can be completely filled with the glue and preventing the optical fibers from being snagged by portions of the guide passages and the front passages not filled with the glue. Further, the step of aligning the guide holding block along with the front end portions of the optical fibers to the front holding block and moving at least one of the front holding block or the optical fibers relative to each other enables a one-time alignment between the optical fibers and the front passages, thereby improving alignment efficiency of the optical fibers.

In some embodiments, prior to the step of inserting first end portions of the plurality of optical fibers into the respective guide passages, the method further includes: separately filling the guide passages and the front passages with the glue; and attaching the guide holding block to the front holding block, such that the guide passages are coaxially aligned with the front passages. In other words, the guide holding block and the front holding block are attached to each other prior to inserting the optical fibers to verify whether the guide passages and the front passages are precisely, thereby ensuring successful insertion of the optical fibers.

After step S150, the method further includes: passing the optical fibers, with the first end portions thereof secured in the holding structure, through a rear slot and a fixing groove each formed in a ferrule body; and securing the holding structure in the fixing groove of the ferrule body. In other embodiments, the optical fibers may be sequentially passed through the rear slot and the fixing groove of the ferrule body prior to inserting the first end portions of the optical fibers into the respective guide passages. According to this method, the optical fibers and the holding structure can be efficiently and firmly assembled with the ferrule body to form the fiber array unit.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

What is claimed is:

1. A fiber array unit, comprising:
a holding structure comprising a front holding block and a guide holding block attached to the front holding block, wherein the front holding block defines a plurality of front passages, and the guide holding block defines a plurality of guide passages arranged in alignment with the front passages; and
a plurality of optical fibers each having a first end portion sequentially passing through the respective guide passages and front passages and secured in the holding structure.

2. The fiber array unit of claim 1, wherein each of the guide passages has a diameter greater than a diameter of each of the front passages.

3. The fiber array unit of claim 2, wherein each of the guide passages defines a guide enlarged opening located at an end of the guide passage away from the front holding block, and the guide enlarged opening has a peripheral surface that radially expands to a diameter greater than that of the guide passage.

4. The fiber array unit of claim 2, wherein each of the front passages defines a front enlarged opening located an end of the front passage adjacent to the corresponding guide passage of the guide holding block, and the front enlarged opening has a peripheral surface that radially expands to a diameter greater than that of the front passage.

5. The fiber array unit of claim 1, wherein the guide holding block has a depth greater than that of the front holding block in an extension direction of the guide passages.

6. The fiber array unit of claim 1, wherein the guide passages are coaxially aligned with the front passages.

7. The fiber array unit of claim 1, further comprising an intermediate holding block disposed between the front holding block and the guide holding block, wherein the intermediate holding block comprises a plurality of intermediate passages located corresponding to the front passages and the guide passages, such that the first end portions of the optical fibers sequentially pass through the respective guide passages, intermediate passages, and front passages.

8. The fiber array unit of claim 1, further comprising a ferrule body, wherein the ferrule body comprises two limiting walls, and defines a fixing groove located between the two limiting walls and a rear slot communicating with the fixing groove, wherein the holding structure is disposed in the fixing groove, and the optical fibers pass through the rear slot to be secured in the holding structure.

9. The fiber array unit of claim 8, wherein the ferrule body is made of a material comprising at least one of liquid crystal polymer, Kovar, or polyphenylene sulfide.

10. The fiber array unit of claim 1, wherein the front holding block and the guide holding block are each made of a material comprising at least one of glass, ceramic, or liquid crystal polymer.

11. An optical coupling apparatus, adapted for optical coupling between a photonic integrated circuit and an associated device, comprising:
a coupling unit comprising a connecting base and a waveguide device disposed on the connecting base; and
a fiber array unit detachably connected to the coupling unit and comprising a ferrule body, a holding structure disposed in the ferrule body, and a plurality of optical fibers;
wherein the holding structure comprises a front holding block and a guide holding block attached to the front holding block, the front holding block defines a plurality of front passages, the guide holding block defines a plurality of guide passages arranged in alignment with the front passages, and the optical fibers sequentially pass through the guide passages and front passages.

12. The optical coupling apparatus of claim 11, wherein the connecting base is disposed on the photonic integrated circuit, the waveguide device is optically coupled to the photonic integrated circuit, and the waveguide device comprises a plurality of optical channels arranged in an array and aligned with the respective front passages.

13. The optical coupling apparatus of claim 11, wherein the ferrule body comprises two limiting walls and defines a fixing groove located between the two limiting walls, the holding structure is disposed in the fixing groove, wherein a plurality of attaching portions are disposed on the limiting walls, and the connecting base comprises a plurality of positioning elements configured to be detachably connected to the attaching portions.

14. The optical coupling apparatus of claim 11, wherein each of the guide passages has a diameter greater than a diameter of each of the front passages.

15. The optical coupling apparatus of claim 14, wherein each of the guide passages defines a guide enlarged opening located at an end of the guide passage away from the front holding block, and the guide enlarged opening has a peripheral surface that radially expands to a diameter greater than that of the guide passage.

16. The optical coupling apparatus of claim 11, wherein the guide holding block has a depth greater than that of the front holding block in a width direction of the guide passages.

17. The optical coupling apparatus of claim 11, wherein the connecting base and the ferrule body are each made of a material comprising at least one of liquid crystal polymer, Kovar, or polyphenylene sulfide.

18. A method for assembling a fiber array unit, comprising:
providing a holding structure comprising a front holding block and a guide holding block configured to be attached to the front holding block, wherein the front holding block defines a plurality of front passages, the guide holding block defines a plurality of guide passages arranged in alignment with the front passages, and each of the guide passages has a diameter greater than that of each of the front passages;
inserting first end portions of a plurality of optical fibers into the respective guide passages; and
moving at least one of the holding structure or the optical fibers relative to each other until the first end portions of the optical fibers pass through the guide passages to be positioned in the respective front passages.

19. The method for assembling the fiber array unit of claim 18, further comprising:
passing the optical fibers, with the first end portions thereof secured in the holding structure, through a rear slot and a fixing groove each formed in a ferrule body; and
securing the holding structure in the fixing groove of the ferrule body.

20. The method for assembling the fiber array unit of claim 18, wherein the inserting the first end portions of the plurality of optical fibers into the respective guide passages further comprises:
filling each of the guide passages of the guide holding block with glue; and
inserting the first end portions of the optical fibers into the respective guide passages until the first end portions protrude from the guide passages toward the front holding block; and
wherein the moving at least one of the holding structure or the optical fibers relative to each other until the first end portions of the optical fibers pass through the guide passages to be positioned in the respective front passages comprises:
filling each of the front passages of the front holding block with glue;
aligning the guide holding block along with the first end portions of the optical fibers to the front holding block, such that the guide passages are coaxially aligned with the front passages;
moving at least one of the front holding block or the optical fibers relative to each other until the first end portions of the optical fibers are positioned in the respective front passages and the guide holding block is attached to the front holding block attaching the guide holding block to the front holding block.
